(19) United States
(12) Patent Application Publication
(10) Pub. No.: US 2007/0113072 A1
(43) Pub. Date: May 17, 2007

(54) Priced-certificate distribution, verification and exchange method utilizing mobile communication

(76) Inventor: Chao-Jung Chen, Taipei City (TW)

Correspondence Address: LIN & ASSOCIATES INTELLECTUAL PROPERTY, P.O. BOX 2339, SARATOGA, CA, 95070-0339, US

(21) Appl. No.: 11/280,368

(22) Filed: Nov. 16, 2005

(51) Int. Cl. H04L 9/00

(52) U.S. Cl. 713/156

(57) ABSTRACT

Disclosed is a method which can be utilized to transmit a priced-certificate to a user of a mobile communication device, and verify and exchange the priced-certificate at a specific transaction site visited by the users of mobile communication device. The method is realized by means of at least a back-stage server device, a plurality of front-stage devices at the transaction site, and the priced-certificate itself. The priced-certificate is sent directly into the mobile communication device by the back-stage server device in an active manner, or it is downloaded into the mobile communication device by the user in a passive manner. The priced-certificate is provided with the built-in modules of program codes and verification information. As such, in a specified period of time, the priced-certificate of the mobile communication device may by input by the user through the front-stage device located at a specific transaction site, and verified by the back-stage server device on-line real-time by making use of the communication connection between them. Thus, realizing the exchange of the priced-certificate in a safe and counterfeiting manner.

### BACKGROUND OF THE INVENTION

1. Field of the Invention

The present invention relates to a priced certificate distribution, verification and exchange method, and in particular to a priced certificate distribution, verification and exchange method utilizing mobile communication.

2. The Prior Arts

Nowadays, the mobile phone handsets have been popularized to almost most of the people, and they have not only change the manner of communication between people, but also affect the ordinary transactions of our daily lives. For example, the network-movie-ticket-reservation-system provided by the service industry to the mobile phone users through the mobile data network (for example, the 2.5 G mobile communication network compatible with the GPRS protocol), which is capable of automatically executing the reservation and booking of the seats for the users of the mobile phones, upon entering by the user of the mobile phone handset: date, name of theater, name of movie, serial show number, number of tickets. Meanwhile, a reservation notice containing the booking code is sent to the user in a short message, so that all the user has to do is to go the theater, bringing with him the reservation notice having the booking code to the wicket of the theater before the movie begins, pay the money and get the ticket. As such, he may enjoy the movie without having to go through the ordinary process of getting into the line and waiting for a long time to buy and get a ticket. That is quite an improvement and convenience for the user of the mobile phone handset. In addition, people in the service industry is further contemplating the design of a kind of mobile phone handset to have the function of value-storage-card and electronic purse, so that people may take a ride on bus or mass rapid transit, or go shopping in a supermarket merely by means of a mobile phone handset.

In the two above-mentioned examples, the ticket reservation notice containing the booking code message is merely a receipt having no monetary value (since the transaction of money with good and service must be done otherwise). However, on the other hand, the mobile phone handset having the functions of the built-in value-storage-card and electronic purse does have monetary value contained therein. In addition, there exists another transaction type between the above-mentioned two types of transactions, that is a kind of certificate having monetary value. In this respect, the most frequent examples of the certificate having monetary value are the coupons appearing in the newspapers and magazines, and the gift-coupons used the department store. Other examples include the exchange certificates of prizes, bonus, and the accumulated points of the on-line game, competition, riddling, and gambling conducted through the mobile phone handset. Such certificates themselves are not the circulating currencies, and are not merely utilized as the receipts either, yet they are rather recognized by some specific stores or service companies as the certificates having monetary value (and thus requiring certain counterfeiting functions). In general, the application of the priced-certificate such as the coupon is always considered as a very effective means of sales promotion. Thus, in addition to being able to raise the value of the priced-certificate itself, the effectiveness of its sales promotion can further be raised significantly, if it is coupled with time limit (the priced-certificate is valid in a certain period of time) and quantity limit (only a certain quantity of priced-certificates are provided) measures.

Presently, in the handset related business operations, there is no prior art which is capable of providing the priced-certificates having the time-limit and effective counterfeiting capabilities, thus the research and development of such a technology is a most urgent task in this field.

### SUMMARY OF THE INVENTION

In view of the shortcomings and limitations of the prior art, the objective of the present invention is to provide a complete solution to the above-mentioned problem through combining the technology of mobile communication and the electronic priced-certificate. Therefore, the present invention provides a method, which is used to transmit a priced-certificate (for example, the exchange certificate of coupon, gift-coupon, prize, bonus) to a user of a mobile communication device (such as the mobile phone handset, or a handheld electronic device having mobile communication capabilities, such as PDA), so that the priced-certificates can be verified and exchanged at the specific transaction sites visited by the users of the mobile communication device.

In the above description, the method of the present invention is realized and implemented in an arrangement, including: at least a back-stage server device, a plurality of front-stage devices provided at the transaction sites, and the priced-certificates itself. As such, the data of the priced-certificate is stored into the mobile communication device of the user in an active manner (for example, it is transmitted directly through the mobile communication network), or in a passive manner (for example, downloaded by the user through the mobile data network)

The priced-certificate is in fact provided with a program module, comprising at least the program codes, and a set of verification information. When the program module is executed, the contents of the priced-certificate (such as, the contents of the sale promotion program, the discount percentage, the discount amount, and the serial number of the priced-certificate) and the operation interface are displayed on the screen of the mobile communication device. The verification information includes at least: the identification code of the mobile communication device (such as the phone number of the mobile phone handset), so as to prevent the priced-certificate from being given to a third party without the user's knowledge; and the identification code of the store recognizing said priced-certificate. One of the functions of the program codes is to start counting the time upon being stored into the mobile communication device, and delete said priced-certificate or mark it as invalid after a predetermined time interval.

Before reaching a predetermined time interval, the priced-certificate of the mobile communication device may be input by the user through the front-stage device located at the specific transaction site, and verified by the back-stage server device on-line real-time by making use of the communication connection between them, thus realizing the exchange of the priced-certificate in a safe and counterfeiting manner. This verification can be done by transmitting the verification information of the priced-certificate to be verified by the mobile communication device to the front-stage device through short-range wireless connections (for example, inferred light wave, Blue Tooth, etc), so that the verification information of the priced-certificate is compared and checked by the front-stage device with the record transmitted and supplied from the back-stage server device through this wireless connection; or it can be done manually by entering the serial number of the priced-certificate through the front-stage device for verification by the back-stage server device; the latter may further transmit a password back to the front-stage device. Thus, if the password can be used to open said priced-certificate, then it is verified that priced-certificate is valid.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is the schematic diagram of the structure of a priced-certificate and its relation to a mobile communication device, usually a mobile phone handset, according to an embodiment of the invention; and

FIG. 2 is the schematic diagram of a configuration of an exchange environment of a priced-certificate according to an embodiment of the invention.

### DETAILED DESCRIPTION OF THE PREFERRED EMBODIMENT

The purpose, construction, features, and functions of the invention can be appreciated and understood more thoroughly through the following detailed description with reference to the attached drawings.

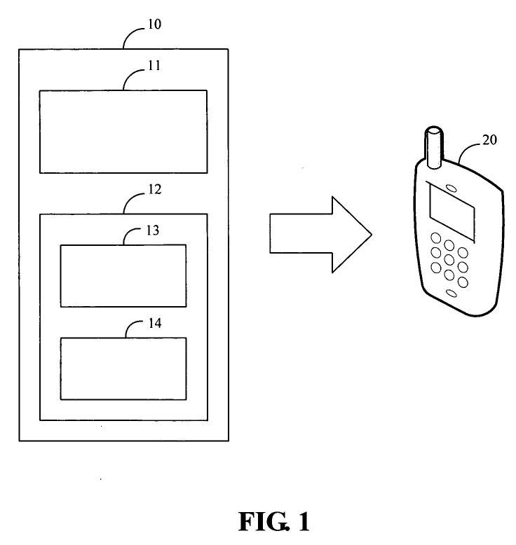

The present invention provides a method, which can be used to transmit a priced-certificate to a user of a mobile communication device, and verify and exchange the priced-certificate at the specific transaction sites visited by the users of the mobile communication device. The priced-certificate utilized in the present invention actually contains a program module. In the terminology of the present mobile communication technology, the program module can be envisioned as a Java game program that can be downloaded and executed repeatedly in the mobile communication device. As shown in FIG. 1, the priced-certificate (or program module) 10 contains at least the program codes 11, and a set of verification information 12. Wherein, the verification information 12 includes a set of open information 13, and a set of hidden information 14. The open information 13 includes at least: (1) the date and time of its being downloaded into the mobile communication device, (2) the unique (namely, it is different from those of other priced-certificates) serial number of the certificate, and (3) the application information (for example, the contents of the activity, the discount percentage or the discount amount, the exchange site or store, and the expiration date). As shown in FIG. 1, upon executing the program module 10, the open information 13 is displayed on the screen of the mobile communication device 20 for the user to inspect. Thus the priced-certificate 10 may have various commercial sales promotion functions depending on the application information contained therein. By way of example, the priced-certificate 10 may be a gift-coupon of a specific commodity exchangeable at the chain stores, the coupon of several percent discount during the exhibition period (or sale promotion period), or the admission ticket for the playground or movie theater, the boarding admission ticket for hotel or spring hostel, or the exchange certificate for the prize or bonus of the on-line game or gambling.

The hidden information 14 comprises at least: (1) the identification number of the mobile communication device, which is used to make sure that the priced-certificate 10 may only exist in a specific mobile communication device; even if it is transferred or duplicated to other mobile communication devices, it will be made invalid due to the incompatibility of the identification number; and (2) the checksum, which is used to make ascertain that the identification information has not been tampered with, the checksum is a value calculated and obtained according to a algorithm by making use of the open and hidden verification information 12. If for any reason, the verification information 12 is tampered with after its download (such as postponing its valid date, or increasing the discount amount), then this priced-certificate 10 will be made invalid, since the value calculated with the same algorithm is different from the checksum recorded in the priced-certificate 10. In addition, the hidden information 14 may further include: (1) the timing function, which is used to invalidate the priced-certificate 10 automatically upon reaching a specific date for the priced-certificate 10 provided with the time limit, and (2) at least a password, and which is provided for use in verifying the validity of the priced-certificate manually, that will be described in detail later.

In general, the program module contained in the priced-certificate 10 may be written in any appropriate language. The program modules written in Java language are most widely utilized in the mobile communication device 20 due to the cross-platform capability of the Java language. However, the scope of the present invention is not limited to this respect that the program module contained in the priced-certificate 10 must be written in certain specific program language. The mobile communication device mentioned in the present invention includes (but not restricted to): mobile phone handset, the personal data assistant (PDA), or any other similar consumer electronic devices which may emerge in the future. Basically, these devices must be able to provide the following capabilities: (1) mobile voice communication capability, regardless of it adopts GSM, PHS, CDMA or any other protocols which might emerge in the future; (2) mobile data communication (or the so-called mobile networking) capability, regardless of it adopts GPRS,3 G, or any other protocols which might emerge in the future; and (3) priced-certificate program code execution capability, such as the capability of supporting the Java execution environment (for example J2ME) etc.

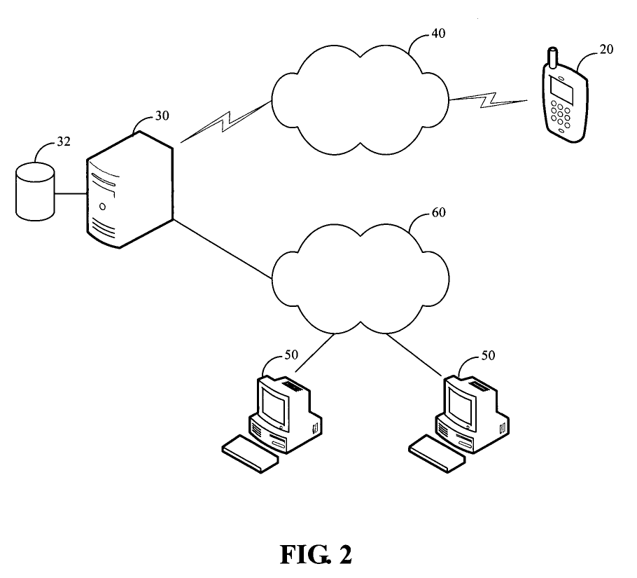

Usually, there are many ways that can be used in entering a priced-certificate 10 into a mobile communication device 20. Among them, the most direct way is similar to downloading the Java game into the ordinary mobile phone handset. As shown in FIG. 2, the mobile communication device 20 of the user is connected to a back-stage server device 30 via a mobile data network 40, then a priced-certificate 10 is downloaded directly into a mobile communication device 20 from back-stage server device 30. The back-stage server device 30 is a server connected to the mobile data network 40. This server usually is provided with a web page application interface used to support WAP protocol, so that the mobile communication device 20 may use the browser. Upon actuating the priced-certificate download process through the web page application interface, the back-stage server device 30 is able to obtain the data (such as the identification code), the download time, password, and the dynamically generated serial number of the mobile communication device 20 automatically in the line-connection process or through entering into the mobile communication device 20 by the user, and prepare ready the verification information (the open information and hidden information) 12 of the priced-certificate 10, then download the priced-certificate 10 into the mobile communication device 20 according to an appropriate communication protocol. This mode of direct download mentioned above is initiated by the user.

In addition, there exists another mode, in which the download of the priced-certificate 10 is initiated by the back-stage server device 30 and is received passively by the user. Usually, before the execution of this mode, the backstage server device 30 is already provided with the user related information (for example, the identification code of the mobile communication device 20), thus, the priced-certificate 10 is transmitted into the mobile communication device 20 from the backstage server device 30 by means of an appropriate messaging mechanism, such as e-mail, acceptable to the mobile communication device 20. Alternately, the web site address of the web page application interface of the back-stage server device 30, such as the IP address or the URL address, is transmitted to the mobile communication device 20 by means of an appropriate messaging mechanism acceptable to the mobile communication device 20 such as e-mail, SMS, EMS, MMS etc., so that the mobile communication device 20 can be connected to said IP address or URL address through a browser. Moreover, please note that, there may be more than one mobile data networks 40 which can be connected to the back-stage server device 30, for example, the back-stage server device 30 may be connected simultaneously to the mobile data network of 2.5 G, 3 G, and possibly the future mobile data network of 4 G and 5 G.

There exists respectively a varied indirect mode for the afore-mentioned user-active-mode and user-passive-mode for downloading the priced-certificate. In either case an additional computer is required. Thus the priced-certificate 10 is first downloaded and transmitted to the computer, then it is transmitted to the mobile communication device 20 through a proper connection, for example, the inferred light wave, Blue Tooth, or USB. No matter what kind of modes utilized, the important point is, upon transmitting the priced-certificate 10 by the back-stage server device 30 and making sure that it is successful, the verification information 12 of the priced-certificate 10 is copied and stored into the data base 32 by the back-stage server device 30. The data base 32 mentioned herein may refer to any device that is capable of storing data, and the data stored therein may be retrieved, revised, or deleted later. It may simply be an ordinary file, or may be an advanced relational data base. The verification information 12 stored in data base 32 is used for the subsequent verification of the priced-certificate 10.

In addition to the back-stage server device 30, one or more front-stage device 50 are provided at the transaction sites (namely, the stores) for recognizing, accepting, and exchanging the priced-certificates 10. The front-stage device 50 may be an ordinary computing device (such as a computer of various types). The important point is, a data network 60 may be connected between the front-stage device 50 and the back-stage server device 30 for exchanging information between them. This particular network may be the public-utilized Internet, or a private network composed of dedicated connection lines, or any other appropriate network. Please note that, there may exist more than one data networks 60 between a front-stage device 50 and a back-stage server device 30.

The exchange of the priced-certificate 10 is realized in the following manner. Firstly, the mobile communication device 20 containing the priced-certificate 10 is brought by the user to the site of a front-stage device 50, and the contents of the priced-certificate 10 is transmitted to the front-stage device 50 through a mechanism (for example, the short-range wireless transmission mechanism of infer-red light wave, BlueTooth etc.) supported by both the front-stage device 50 and the mobile communication device 20. Then, the verification information 12 of the priced-certificate 10 is transmitted real-time by the front-stage device 50 to the back-stage server device 30. Subsequently, the verification information 12 is compared with its copy in the data base 32 by the back-stage server device 30 to verify its validity. And finally the result of the verification is transmitted back to the front-stage device 50. Thus, the people working at the exchange site may determine whether to accept and exchange the priced-certificate according to the results of the verification. The above-mentioned steps belong to an automatic verification process.

Alternatively, there exist a manual verification process. Namely, firstly, a portion of the open information 13 of the verification information 12 of a priced-certificate 10 is entered by the people working at the front-stage device 50, that can be used to identify the priced-certificate, such as the name of sales promotion activity, the serial number of the priced-certificate 10. Next, this information is transmitted real-time by the front-stage device 50 to the back-stage server device 30 through the data network 60. Then, the information received is used by the back-stage server device 30 to search and retrieve the related data in the data base, if the corresponding verification information is found in the data base, then the password in the hidden information 14 of the corresponding verification information is transmitted real-time to the front-stage device 50, so that the people working at the exchange site may enter this password into the application interface of the priced-certificate 10, then the program codes 11 of the priced-certificate 10 is utilized to check if the entered password is the same as that originally recorded in the priced-certificate 10. If the answer if affirmative, then it is verified that this priced-certificate 10 is valid.

As to the priced-certificate 10 having valid time limitations, two methods are provided in the present invention to control its validation. The first one is the verification-on-exchange method, since the valid date of the priced-certificate 10 is recorded in the open information 13 of its verification information 12, so that the people working at the transaction site may certify if the priced-certificate is still within the valid date simply by visual inspection. If the valid date is not explicitly expressed in the open verification information 13, then during the verification/examination conducted by the back-stage server device 30 (regardless it is automatic of manual), the check of validation is done based on the contents of the copied verification information 12 in the data base 32. The second method used in controlling the validation of the priced-certificate is an automatic invalid method, wherein its validation is controlled by the count-down of the valid time remains, namely, the priced-certificate is invalidated after a preset period of time (thus, it is not determined by a specific time point). Moreover, this method of automatic invalid requires the constant execution of the program codes 11 in the priced-certificate 10. Namely, upon downloading the priced-certificate 10, the program codes 11 is used to count the time unceasingly according to the real-time clock of the mobile communication device 20. Since the valid period remains is measured by count-down of the time, thus it will not be affected by any deviations between time of the real-time clock of the mobile communication device 20 and the real time, and whether the mobile communication device 20 is power off. By way of example, upon being downloaded, the program codes 11 of priced-certificate 10 is used to read immediately the time T of the real-time clock at that time, then read unceasingly and periodically the time T′ of the real-time clock and compare to see if T′-T has exceeded the time limit set for the count-down. As such, even if the mobile communication device 20 is power-off so that the program codes 11 is ceased from executing, however, once the mobile communication device 20 is power-on again, the program codes 11 will again read unceasingly and periodically the time T′ of the real-time clock and make the similar comparison. Even if the time of real-time clock is changed by the user, the program codes 11 can be so designed that it may automatically adjust the recorded time T of its download, thus there will be no misjudgment of the validity of the priced-certificate.

In utilizing the automatic invalid method, when it is discovered by the program codes 11 that the priced-certificate 10 is invalid, then the program codes 11 may: (1) automatically revise the open verification information 13, and mark that the priced-certificate 10 is invalid, thus the user can read directly the message, or (2) remove or delete the priced-certificate 10 directly, so that it will disappear from the mobile communication device 20.

The above detailed description of the preferred embodiment is intended to describe more clearly the characteristics and spirit of the present invention. However, the preferred embodiments disclosed above is not intended to be any restrictions to the scope of the present invention. Conversely, its purpose is to include the various changes and equivalent arrangements which are within the scope of the appended claims.

What is claimed is:

1. A priced-certificate distribution, verification and exchange method utilizing mobile communication, comprising the following steps:
providing an environment including at least a back-stage server device and a plurality of front-stage devices, at least a mobile data network is provided between said back-stage server device and said plurality of front-stage devices for transmitting data between them, said back-stage server device is provided with a data base for data storage and retrieval, and is connected to at least a mobile data network;
providing at least a priced-certificate through said mobile data network to at least a mobile communication device connected to said mobile data network by making use of said back-stage server device, said priced-certificate includes: at least a program module executable by said mobile communication device, and a set of verification information, said set of verification information is stored into said data base by said back-stage server device after the transmission; and
connecting said front-stage device through said data network to said back-stage server device, which is used to verify the exchange validity of a priced-certificate stored in a mobile communication device in a proper manner.

2. The priced-certificate distribution, verification and exchange method utilizing mobile communication as claimed in claim 1, wherein
said verification information of said priced-certificate includes at least the following open information: (1) date and time of its being downloaded into said mobile communication device; (2) the unique serial number of said priced-certificate; (3) the exchangeable value.

3. The priced-certificate distribution, verification and exchange method utilizing mobile communication as claimed in claim 1, wherein
said verification information of said priced-certificate includes at least the following hidden information: (1) the identification number of said mobile communication device, which is used to verify that said priced-certificate may only exist in said specific mobile communication device; and (2) a checksum, which is used to certify that said verification information has not been tampered with, said checksum is a value calculated and obtained according to an algorithm.

4. The priced-certificate distribution, verification and exchange method utilizing mobile communication as claimed in claim 1, wherein
said mobile communication device includes at least: (1) mobile voice communication capability; (2) mobile data communication capability; and (3) the capability of executing said program codes of said priced-certificate.

5. The priced-certificate distribution, verification and exchange method utilizing mobile communication as claimed in claim 1, wherein
said back-stage server device further includes an application interface, so that the way of providing said priced-certificate to said mobile communication device is: said mobile communication device takes the initiative connecting itself to said back-stage server device through said mobile data network, and downloading said priced-certificate into said mobile communication device through said application interface.

6. The priced-certificate distribution, verification and exchange method utilizing mobile communication as claimed in claim 1, wherein
the way of providing the priced-certificate to said mobile communication device is: said back-stage server device takes the initiative transmitting said priced-certificate to said mobile communication device through said mobile data network by making use of a message containing said priced-certificate.

7. The priced-certificate distribution, verification and exchange method utilizing mobile communication as claimed in claim 1, wherein
the way of verifying said priced-certificate is: said priced-certificate of a mobile communication device is transmitted through an appropriate transmission mechanism to said front-stage device, then said verification information of said priced-certificate is transmitted by the front-stage device to said back-stage service device through said data network, and it is checked by the back-stage server device with the verification information stored in the data base to verify the validity of said verification information, and finally the check result is transmitted back to said front-stage device through said data network.

8. The priced-certificate distribution, verification and exchange method utilizing mobile communication as claimed in claim 1, wherein
the appropriate transmission mechanism is a short-range wireless transmission mechanism.

9. The priced-certificate distribution, verification and exchange method utilizing mobile communication as claimed in claim 1, wherein
the way of verifying said priced-certificate is: an identification information of said verification information is input manually into said front-stage device, then it is transmitted to said back-stage server device by the front-stage device through said data network, and it is utilized by the back-stage server device to retrieve a specific information in said data base, then the retrieved specific information is transmitted back to said front-stage device through said data network, said password is input manually into said mobile communication device, and said program codes of said priced-certificate is used to check if said specific information is correct, thus verifying the validity of said priced-certificate.

10. The priced-certificate distribution, verification and exchange method utilizing mobile communication as claimed in claim 9, wherein
said specific information is a hidden password of said priced-certificate.

11. The priced-certificate distribution, verification and exchange method utilizing mobile communication as claimed in claim 9, wherein
said verification information of said priced-certificate includes an open time limit information.

12. The priced-certificate distribution, verification and exchange method utilizing mobile communication as claimed in claim 1, wherein
upon being transmitted into said mobile communication device, said program codes in said priced-certificate executes an automatic timing function, such that when a specific time limit is reached, said priced-certificate is invalidated in a proper way.

13. The priced-certificate distribution, verification and exchange method utilizing mobile communication as claimed in claim 12, wherein
the proper way in invalidating the priced-certificate is to put an open information in said verification information to indicate that said priced-certificate has passed its valid date.

14. The priced-certificate distribution, verification and exchange method utilizing mobile communication as claimed in claim 12, wherein
the proper way in invalidating the priced-certificate is to remove said priced-certificate from said mobile communication device automatically.
